(19) United States
(12) Patent Application Publication
(10) Pub. No.: US 2015/0261042 A1
(43) Pub. Date: Sep. 17, 2015

(54) SURFACE LIGHT-EMITTING DEVICE AND LIQUID CRYSTAL DISPLAY APPARATUS

(71) Applicant: NLT Technologies, Ltd., Kawasaki (JP)

(72) Inventor: Hiroki SUGAYA, Kanagawa (JP)

(73) Assignee: NLT Technologies, Ltd., Kawasaki (JP)

(21) Appl. No.: 14/657,460

(22) Filed: Mar. 13, 2015

(30) Foreign Application Priority Data
Mar. 17, 2014 (JP) 2014-052915

(51) Int. Cl. G02F 1/1335; F21V 9/00; F21V 7/00

(52) U.S. Cl. CPC G02F 1/133605; G02F 1/133603; G02F 1/133606; F21V 7/0066; F21V 9/00; F21Y 2113/005

(57) ABSTRACT

Provided are a surface light-emitting device and a liquid crystal display apparatus. The surface light-emitting device includes: a casing; one or plural point light sources arranged on a bottom surface of the casing; a first diffusion member arranged to be separated from the one or plural point light sources; a reflection plate capable of transmitting light and arranged between the one or plural point light sources and the first diffusion member; and a second diffusion member adjacent to the reflection plate. In the reflection plate, through holes are formed in a region corresponding to each of the one or plurality of point light sources. The through holes in the region are located at the right above position of the corresponding point light source and positions surrounding the right above position such that the through hole located farther from the right above position has a greater opening size.

### TECHNICAL FIELD

The present invention relates to a surface light-emitting device and a liquid crystal display apparatus. In particular, the present invention relates to a surface light-emitting device that uses a LED (Light Emitting Diode) as a light source, and to a liquid crystal display apparatus that uses such a surface light-emitting device as a backlight device.

### BACKGROUND

As compared with fluorescence tubes (hot cathode tubes and cold cathode tubes), light emitting diodes (LEDs) have various characteristics, such as a reduced environmental load coming from their material being free from mercury, excellent color reproducibility, excellent responsiveness, a broad range of luminance adjustability, and a long life. Accordingly, LEDs are now expected as a new type of light source. Furthermore, in recent years, with an increase of the possible output power of LEDs, a use of LEDs in various kinds of device, such as illuminations and projector light sources requiring high luminance and backlight devices for large-sized liquid crystal display apparatuses, is increasing.

Among such applications, a surface light-emitting device using LEDs, such as a backlight for large-sized liquid crystal display apparatuses, needs to use a method to convert light of LEDs into planar light, since LEDs are point light sources with strong directivity. There are two representative methods for such a purpose, namely, an edge-light method and a direct-light method.

In the edge-light method, a light guide plate is arranged on a light-emitting surface of a surface light-emitting device, and LEDs are arranged in line on the side (or sides) of the light guide plate. The light emitted from the LEDs is guided by the light guide plate into a perpendicular direction of the light guide plate, to be converted to planar light. Meanwhile, in the direct-light method, a diffusion plate is arranged on the light-emitting surface of a surface light-emitting device, and LEDs are arranged in matrix on a surface facing the diffusion plate. The light from the LEDs is diffused with the diffusion plate to be converted into planar light. As compared with the edge-light method, the direct-light method has an advantage of being easier to increase the luminance of the light-emitting device since an increased number of LEDs can be arranged therein. Thus, the direct-light method is suitable for comparatively large-sized backlights.

However, since LEDs are point light sources with strong directivity, there is a problem in the direct-light method that local luminance non-uniformity tends to occur at a position corresponding to each LED. In view of this problem, there have been proposed several methods such as a method of increasing the distance from a surface where LEDs are arranged to a light-emitting surface of a surface light-emitting device so as to mix light of a LED concerned and light of surrounding LEDs, and a method of densely arranging LEDs so as to mix light of the LEDs. However, reducing the thickness of a surface light-emitting device employing such a method and the cost of the same are difficult. In view of such problems of the direct-light method, there have been proposed technologies to arrange a reflection member in which openings are formed above LED light sources.

For example, Japanese Examined Patent Application Publication (JP-B) No. 4280283 (corresponding to US2009/0003002A1) discloses the following planar illumination light source device. The planar illumination light source device includes a highly directional point-light source and a casing, where the casing has a bottom plate and a side plate having predetermined sizes and further has an opening. On the inner wall surface of the casing, an inner reflection part and a side reflection part which can reflect and diffusely reflect light. The planar illumination light source device further includes a light-radiation-side reflection means which covers the opening and can transmit, reflect and diffusely reflect light. In the casing, the light source is arranged on the central part of the bottom plate. The light-radiation-side reflection means includes a central reflection part located right above the point light source and extending in a prescribed area, and a peripheral reflection part surrounding the central reflection part. The peripheral reflection part is made of a reflective material which can partly transmit, reflect and diffusely reflect light and has a prescribed reflectance. The central reflection part is made of a reflective material with optical transparency having a higher reflectance than that of the peripheral reflection part.

Moreover, in Japanese Unexamined Patent Application Publications (JP-A) No. 2012-174372 discloses the following illumination device of a direct-light type. The illumination device is arranged at a rear side of a display panel, and includes a plurality of illumination units for emitting light and a diffusion plate for diffusing the light emitted from the plurality of illumination units, wherein the device illuminates the display panel with light diffused by the diffusion plate. Each illumination unit includes an LED light source, a reflection plate, and a reflection member. In each illumination unit, the reflection plate is arranged between the LED light source and the diffusion plate, has an opposing part that faces the LED light source and is a part of the surface facing the LED light source of the reflection plate, and is made of a material which can reflect light without transmitting light. In each illumination unit, the reflection member faces a region other than the opposing part in the surface facing the LED light source of the reflection plate, and the reflection member can reflect light once reflected on the reflection plate toward the reflection plate. In the reflection plate, there are formed a plurality of light-passing holes which communicate between the LED light source side and the diffusion plate side of the reflection plate, wherein the light-passing hole at a shorter distance from the opposing part has a smaller opening size, and the light-passing hole formed in the opposing part has the smallest opening size among the plurality of light-passing holes.

In addition, PCT International Publication WO2011/162258 (corresponding to US2013/0094216A1) discloses the following technology, which is directed to an invention related to an illumination device rather than a liquid crystal display apparatus. The disclosed illumination device includes a point light source, a substrate where the point light source is mounted, and a cylindrical frame, and further includes a bottom-surface reflection part, a side-surface reflection part, and a light-transmissive reflection plate which are arranged in the frame. The light-transmissive reflection plate has light transmittance that increases as the distance from the point light source becomes longer and light reflectance that decreases as the distance from the point light source becomes longer.

JP-B No. 4280283 describes that “the central reflection part is formed of a reflective material with optical transparency having a higher reflectance than that of the peripheral reflection part”, and there are no through holes formed in the central reflection part of the light-radiation-side reflection means (namely, a region extending within a predetermined range encompassing a position right above the point light source). As written in Applicant's Argument submitted to the Japan Patent Office on Sep. 1, 2008, the reason is that light coming from the LED can directly go out from the planar illumination light source device if a through hole is formed in the central reflection part of the light-radiation-side reflection means. Such a structure significantly increases the luminance of the central reflection part to form a bright spot, and hardly maintains the luminance uniformity of the planar illumination light source device. On the other hand, the disclosed structure works so as to reduce the luminance around the central reflection part, and thus also the luminance of the other portion other than the central reflection part needs to be decreased in order to maintain the luminance uniformity as the whole of the planar illumination light source device. Accordingly, the luminance of the entire planar illumination light source device is decreased.

WO2011/162258 describes “the light-transmissive reflection plate 3 has a predetermined thickness and is formed to have high light reflectance and low light transmittance” in paragraph of 0045, and further describes “the central portion 3a1 is formed to have high light reflectance” in paragraph of 0046. Similarly to the above, such a structure works to reduce the light transmittance of the central portion, and thus also the luminance of the other portion other than the central portion needs to be decreased in order to maintain the luminance uniformity as a whole. Accordingly, the luminance of the entire device is decreased. In addition, it is further described that the light transmittance of the central portion is set as appropriate by, for example, formation of half-depth slits and adjustment of the plate thickness. However, there is still a limit in improvement in the light transmittance of the central portion and it is hard to prevent the decrease in the luminance of the entire illumination device.

JP-A No. 2012-174372 discloses the structure that a reflection plate is made of a non-light-transmissive material and a diffusion plate is arranged above the reflection plate. However, a use of diffusion plate hardly controls the in-plane luminance non-uniformity between a portion of the light-passing hole (namely, a portion where light is not reflected by the non-light-transmissive material) and the other portion (namely, a portion where light is reflected by the non-light-transmissive material), and thus sufficient in-plane luminance uniformity cannot be maintained.

Furthermore, in all of JP-B No. 4280283, JP-A No. 2012-174372 and WO2011/162258, one LED light source is comparted with a casing or a housing, and the opening sizes of through holes formed in the light-radiation-side reflection means, the light-transmissive reflection plate, or the reflection plate becomes larger gradually as getting farther from the center of the comparted region. However, in a structure such that a plurality of LED light sources are arranged in one case (each LED light source is not comparted with a casing or a housing) and through holes are formed such that the through hole has the maximum opening size in a portion corresponding to the middle of neighboring LED light sources, the luminance in the portion becomes higher as a result of the interaction of light from the neighboring LED light sources, and thus luminance uniformity worsens.

The present invention seeks to solve the problems.

### SUMMARY

In view of the above-described problems, there are provided illustrative surface light-emitting devices and illustrative liquid crystal display apparatuses, where the surface light-emitting devices are those of a direct-light type which can convert light from point light sources with strong directivity into planar light and can improve the luminance of the entire device while maintaining the luminance uniformity.

A surface light-emitting device according to one aspect of the present invention comprises: a casing; one or a plurality of point light sources arranged on a bottom surface of the casing; a first diffusion member arranged at a light-outgoing side of the one or plurality of point light sources to be separated from the one or plurality of point light sources; and a reflection plate capable of transmitting light and arranged between the one or plurality of point light sources and the first diffusion member. In the reflection plate, through holes are formed in a region corresponding to each of the one or plurality of point light sources, the through holes in the region are located at a right above position of the corresponding point light source and positions surrounding the right above position such that the through hole located farther from the right above position has a greater opening size. The surface light-emitting device further comprises a second diffusion member adjacent to the reflection plate and facing the one or plurality of point light sources or the first diffusion member.

A liquid crystal display apparatus according to one aspect of the present invention comprises the above-described surface light-emitting device; and a liquid crystal panel facing a light-emitting surface of the surface light-emitting device.

Other features of illustrative embodiments will be described below.

### BRIEF DESCRIPTION OF THE DRAWINGS

Embodiments will now be described, by way of example only, with reference to the accompanying drawings which are meant to be exemplary, not limiting, and wherein like elements numbered alike in several figures, in which:

FIG. 1A is a cross-sectional view of a surface light-emitting device according to EXAMPLE 1;

FIG. 1B is an assembly diagram of the entire liquid crystal display apparatus according to EXAMPLE 1;

FIGS. 2A to 2C are diagrams for illustrating the light intensity distribution of an LED light source arranged in the surface light-emitting device according to EXAMPLE 1;

FIGS. 3A and 3B illustrate an arrangement of LED light sources in the surface light-emitting device according to EXAMPLE 1;

FIG. 4A is an overall view of a light-transmissive reflection plate according to EXAMPLE 1;

FIG. 4B is an enlarged view of a region corresponding to one LED light source according to EXAMPLE 1;

FIGS. 5A, 5B and 5C are diagrams for comparing a structure according to the present example with structures of JP-B No. 4280283 and JP-A No. 2012-174372;

FIGS. 6A and 6B are diagrams for illustrating luminance distribution of light which has passed through a light-transmissive reflection plate (per LED light source) in the structure of EXAMPLE 1;

FIGS. 7A and 7B are diagrams for illustrating luminance distribution of light which has passed through a reflection plate (per LED light source) in the structure disclosed in JP-B No. 4280283;

FIGS. 8A and 8B are diagrams for illustrating luminance distribution of light which has passed through a reflection plate (per LED light source) in the structure disclosed in JP-A No. 2012-174372;

FIG. 9 is a graph for comparing effects of the structure according to the present example with effects of the structures of JP-B No. 4280283 and JP-A No. 2012-174372;

FIG. 10A is an overall view of the light-transmissive reflection plate having a structure in which the opening sizes of the through holes between LED light source changes gradually;

FIGS. 10B and 10C are enlarged views of the light-transmissive reflection plate of FIG. 10A;

FIG. 11A is an overall view of the light-transmissive reflection plate having a structure including regions in each of which the through holes between the LED light sources have the same and constant opening size (structure of EXAMPLE 2);

FIGS. 11B and 11C are enlarged views of the light-transmissive reflection plate having the structure of FIG. 11A;

FIGS. 12A and 12B are diagrams for illustrating luminance distribution of light which has passed through the light-transmissive reflection plate (per LED light source) in a structure in which the opening sizes of the through holes between LED light sources change gradually;

FIGS. 13A and 13B are diagrams for illustrating luminance distribution of light which has passed through the light-transmissive reflection plate (per LED light source) in a structure (structure of EXAMPLE 2) including regions in each of which the through holes between the LED light sources have the same and constant opening size;

FIG. 14A illustrates an arrangement of LED light sources according to EXAMPLE 3;

FIG. 14B is an overall diagram of the light-transmissive reflection plate according to EXAMPLE 3;

FIG. 14C is a partial enlarged view of the light-transmissive reflection plate of FIG. 14B; and

Each of FIGS. 15A and 15B illustrates an arrangement of LED light sources according to EXAMPLE 4.

### DETAILED DESCRIPTION

Illustrative embodiments of surface light-emitting devices and liquid crystal display apparatuses will be described below with reference to the drawings. It will be appreciated by those of ordinary skill in the art that the description given herein with respect to those figures is for exemplary purposes only and is not intended in any way to limit the scope of potential embodiments may be resolved by referring to the appended claims.

According to the illustrative surface light-emitting device of a direct-light type which can convert light from point light sources with strong directivity into planar light, luminance of the entire device can be improved while maintaining the luminance uniformity and display quality of the liquid crystal display apparatus that uses the surface light-emitting device as a backlight device can be improved, because of the following structure.

That is, there are provided a light-transmissive reflection plate (in other words, a reflection plate capable of transmitting light) arranged between one or more point light sources and a first diffusion member arranged near a liquid crystal panel. In the reflection plate, through holes are formed at a right above position of each of the one or more point light source and positions surrounding the right above position such that opening sizes of the through holes gradually increase as the locations of the through holes get farther from the right above position of the each of the one or more point light sources. Further, a second diffusion member is arranged on the light-outgoing side (or light-entering side) of the light-transmissive reflection plate.

Thus, reduction of luminance in the central region including the portion right above each point light source can be controlled as a result of forming in the light-transmissive reflection plate the through hole formed right above each point light source; and luminance variation in the central region and the surrounding region can be reduced as a result of transmission of light through the light-transmissive reflection plate and diffusion of light in the second diffusion member.

In addition, in cases where a plurality of point light sources are arrayed in the device, by way of providing a light-transmissive reflection plate including regions in each of which though holes having the same and constant opening size are formed, and each of the regions corresponds to the middle of neighboring point light sources, an increase in luminance on a portion corresponding to the middle of the neighboring point light sources due to interactions of both point light sources can be suppressed.

As described in the descriptions of the background, since LEDs are point light sources with strong directivity, the direct-light method has a problem that local luminance non-uniformity (uneven distribution of in-plane luminance) tends to occur in a location corresponding to an LED light source. In order to deal with this problem, JP-B No. 4280283, JP-A No. 2012-174372 and WO2011/162258 disclose structures in which there is arranged a reflection member provided with an opening formed above the LED light source so as to reduce the local luminance non-uniformity.

However, since there is formed no through hole at a position right above the LED light source in the light-radiation-side reflection means or the light-transmissive reflection plate in JP-B No. 4280283 and WO2011/162258, the luminance at the position right above the LED light source is reduced, and therefore there is a need to decrease the luminance in the surrounding region other than the central region including the position right above the LED light source in order to maintain luminance uniformity. Thus, the luminance of the entire illumination device is decreased. In addition, the through hole is formed at the position right above the LED light source in the reflection plate in JP-A No. 2012-174372. However, since the reflection plate is formed of a non-light-transmissive material, the luminance on the position right above the LED light source increases remarkably and thus it is hard to reduce luminance variation sufficiently.

Further, in JP-B No. 4280283, JP-A No. 2012-174372 and WO2011/162258, one LED light source is comparted with a casing or a housing, and the opening sizes of through holes provided in the light-radiation-side reflection means, the light-transmissive reflection plate, or the reflection plate are made larger as getting farther from the center of the comparted region. However, if this structure is applied to a structure in which a plurality of LED light sources are arranged in one case and through holes are formed such that a through hole having the maximum opening size is formed in a portion corresponding to the middle of the neighboring LED light sources, the luminance in the portion corresponding to the middle of the LED light sources can increase due to interaction between the neighboring LED light sources, and thus luminance uniformity can be deteriorated.

That is, although it is necessary to make the luminance at the position right above the LED light source high in order to increase the luminance of the entire surface light-emitting device, excessively-high luminance at the position right above the LED light source increases the luminance variation. Further, if the interaction between the neighboring LED light sources is not taken into consideration, the luminance in the portion corresponding to the middle of the LED light sources increases, which results in an increase of the luminance variation. Therefore, the kind of material of the reflection plate, where in the reflection plate through holes are formed, and how large is the opening of the through holes are important in order to manufacture a surface light-emitting device that has large luminance, i.e., bright entire surface, and has excellent in-plane luminance uniformity.

In view of that, in an embodiment of the present invention, there is provided a surface light-emitting device including one or plural LED light sources and a first diffusion member arranged at the light-outgoing side of the one or plural light sources with a space put between the first diffusion member and the one or plural light sources, wherein each LED light source has one or more LED chips packaged. A light-transmissive reflection plate, which is capable of transmitting light, is arranged between the one or plural LED light source and the first diffusion member. In the light-transmissive reflection plate, through holes are formed at the right above position of each point light source and the surrounding positions such that the through hole located farther from the right above position has a greater opening size. A second diffusion member is further arranged on a light-outgoing-side or a light-entering-side of the light-transmissive reflection plate. Optionally, in a case that plural point light sources are employed in the surface light-emitting device, the reflection plate may include constant-opening regions in each of which through holes having a same opening size are formed, where each of the constant-opening regions is located above a middle of the neighboring point light sources.

Thereby, it is possible to improve luminance of the entire surface light-emitting device while maintaining the in-plane luminance uniformity of the surface light-emitting device.

### EXAMPLES

### Example 1

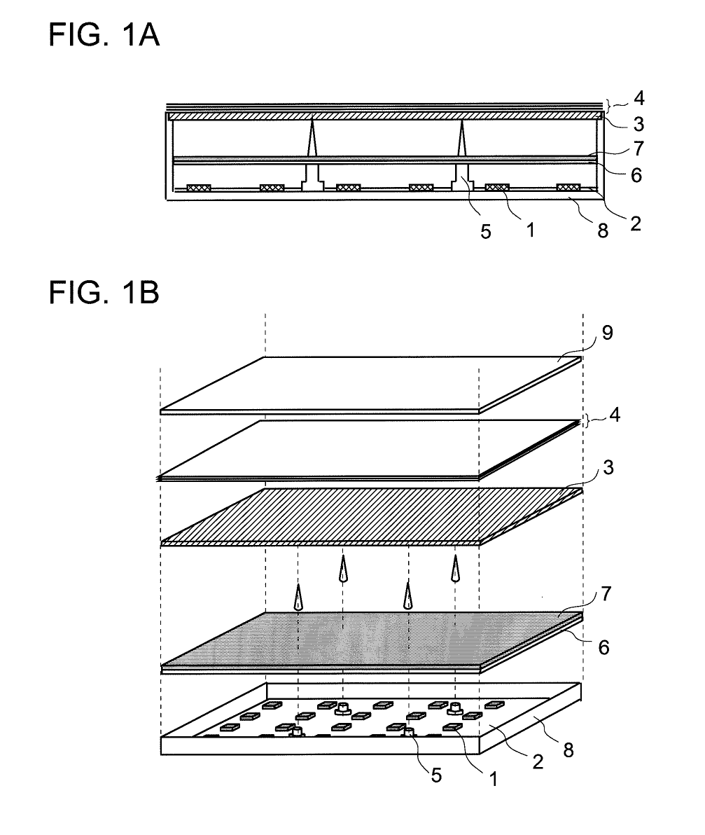

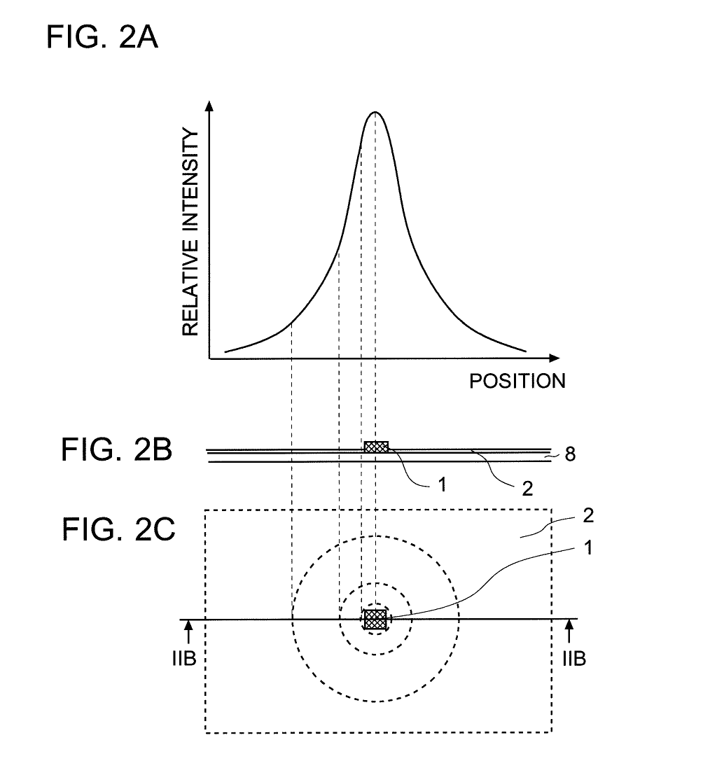

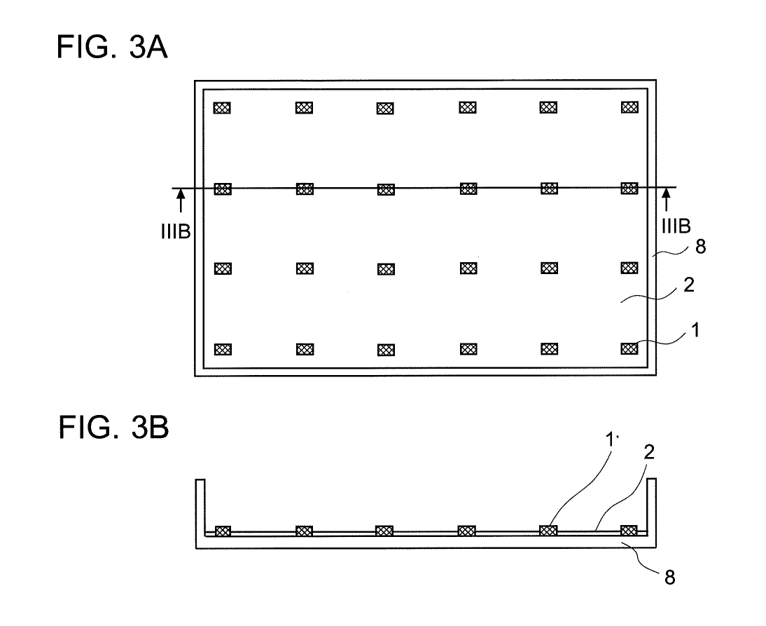

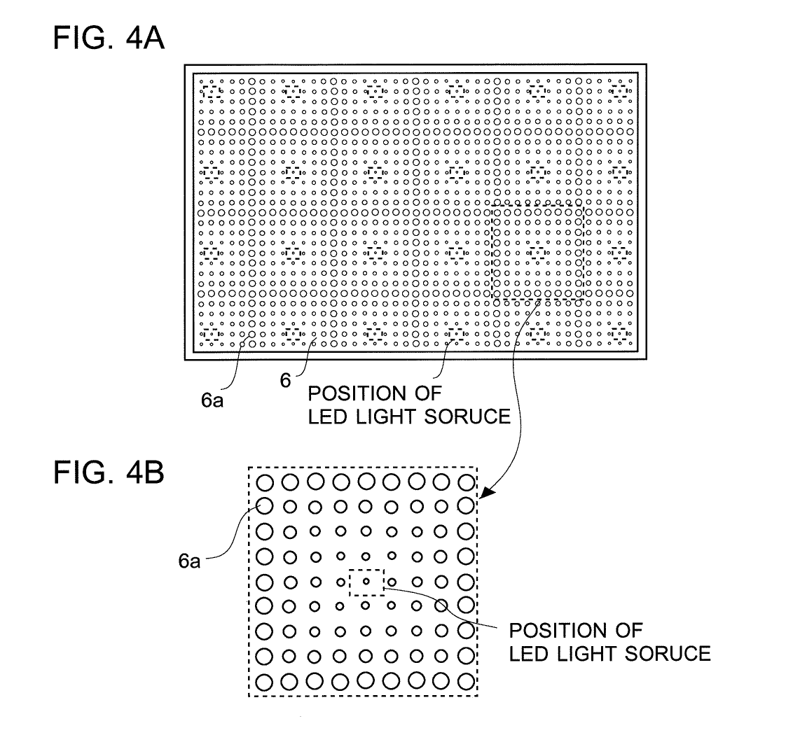

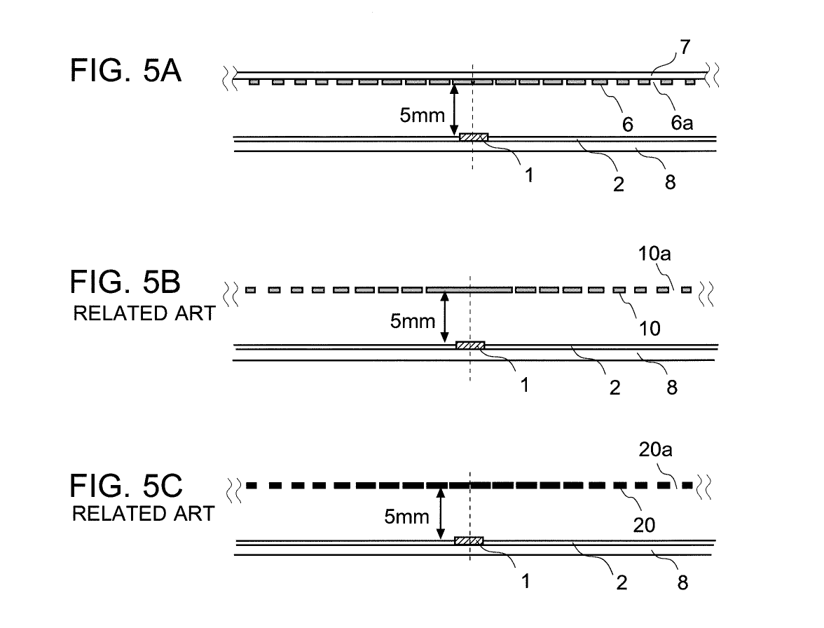

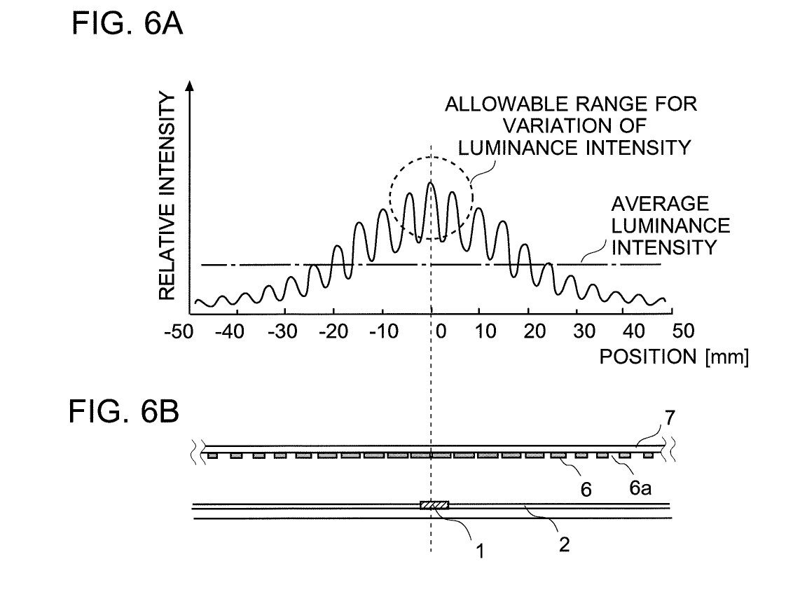

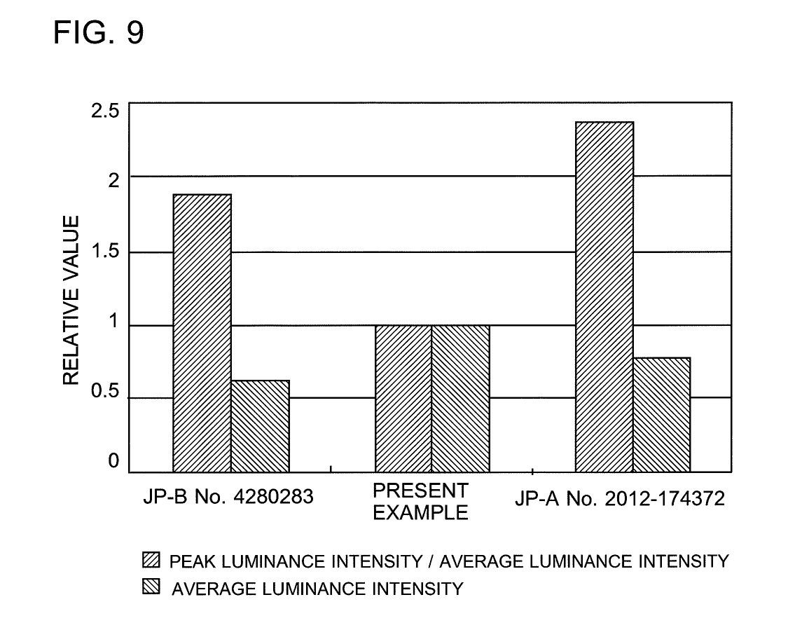

The above-described embodiments of the present invention will be described in detail. The surface light-emitting device and the liquid crystal display apparatus of EXAMPLE 1 will be described with reference to FIGS. 1A to 9. FIGS. 1A and 1B are a cross-sectional view of the surface light-emitting device and an assembly diagram of the entire liquid crystal display apparatus of the present example, respectively. FIGS. 2A to 2C is a graph illustrating light intensity distribution of a single LED light source, a cross-sectional view of the single LED light source taken along the line IIB-IIB of FIG. 2C, and a plan view of the single LED light source. FIGS. 3A and 3B illustrate an in-plane arrangement of LED light sources. FIG. 4A is an overall view of the light-transmissive reflection plate of the present example. FIG. 4B is an enlarged view of a region corresponding to one LED light source of the present example. FIGS. 5A, 5B and 5C illustrate comparison of a structure of the present example with structures disclosed in JP-B No. 4280283 and JP-A No. 2012-174372. FIGS. 6A to 8A illustrate luminance distribution of light which has passed through the reflection plate in the structure of the present example, JP-B No. 4280283 and JP-A No. 2012-174372. FIG. 9 illustrates comparison of effects of the present embodiment, JP-B No. 4280283 and JP-A No. 2012-174372.

The surface light-emitting device of the present example is a device which can convert light emitted from light emitters, such as LEDs, into planar light. The surface light-emitting device can be used as a backlight unit in a liquid crystal display apparatus, an illumination appliance, a signboard, a light box, and other device. Hereafter, cases where the surface light-emitting device of the present example is used as a backlight unit of a liquid crystal display apparatus will be described below.

FIG. 1A is a cross-sectional view schematically illustrating the structure of the surface light-emitting device of the present example. FIG. 1B is an assembly diagram of the liquid crystal display apparatus of the present example. It should be noted that, the size and shape of each component have been adjusted as appropriate in FIGS. 1A and 1B in order to make the structure of each component of the surface light-emitting device easy to understand.

As shown in FIGS. 1A and 1B, the surface light-emitting device of the present example includes, for example, LED light sources 1, a bottom-surface reflection plate 2, a first diffusion member 3, an optical sheet 4, support pins 5, a light-transmissive reflection plate 6, a second diffusion member 7, and a backlight casing 8.

The backlight casing 8 has a structure whose cross section includes bent portions each forming an L-shape. On the bottom surface of the backlight casing 8, there is arranged the bottom-surface reflection plate 2 in which openings are formed to be arranged in a matrix form at regular intervals. An LED light source 1, being a point light source with strong directivity, is arranged in each of the openings of the bottom-surface reflection plate 2 and is mounted on a mounting board. The mounting board is fixed onto the bottom surface of the backlight casing 8 with, for example, adhesive material. On the bottom-surface reflection plate 2, one or more support pins 5 are arranged at predetermined position or positions between the LED light sources 1. With the one or more support pins 5, the light-transmissive reflection plate 6 and the second diffusion member 7 are supported such that their distance from the LED light source 1 is fixed, and are fixed with inner walls of the backlight casing 8 so as to be clamped with the inner walls. Furthermore, a first diffusion member 3 and an optical sheet 4, such as a prism sheet, are arranged to cover the opening of the backlight casing 8 and they are supported by the top surface of the backlight casing 8 and the one or more support pins 5. A liquid crystal panel 9 is arranged so as to face at the top surface (light-emitting surface) of the surface light-emitting device including the above components, thus forming a liquid crystal display apparatus.

Each LED light source 1 forms a package in which one LED, such as a white LED (W-LED), is mounted on the mounting board.

The bottom-surface reflection plate 2 is formed of a material, such as a white PET (polyethylene terephthalate) film and a white PP (polypropylene) film, and can reflect direct light coming from the LED light sources 1 and light reflected by the light-transmissive reflection plate 6, toward the light-transmissive reflection plate 6. In addition, the bottom-surface reflection plate 2 may include ultraviolet absorber inside, or may be provided with an ultraviolet absorption film on its surface. By adding such a material, yellowing of the bottom-surface reflection plate 2 due to ultraviolet rays from the LED light source 1 can be reduced, and thus it is possible to obtain the reflectance being stable in the long run and to lengthen the life in regard to the luminance of the surface light-emitting device.

The first diffusion member 3 and the second diffusion member 7 are components in which optical diffusion agent, such as acrylic and silicone, is dispersed in a base material made of, for example, MS (styrene methyl methacrylate copolymer) type resin and PS (polystyrene) type resin. The light coming from the light-transmissive reflection plate 6 is scattered in the second diffusion member 7 and the first diffusion member 3. It should be noted that, although the second diffusion member 7 is arranged on the light-outgoing-surface side of the light-transmissive reflection plate 6 (to face the first diffusion member 3) in FIGS. 1A and 1B, the second diffusion member 7 may be arranged on the light-entering-surface side of the light-transmissive reflection plate 6 (to face the LED light source 1) or the second diffusion members 7 may be arranged on both the light-outgoing-surface side and light-entering surface side of the light-transmissive reflection plate 6.

The light-transmissive reflection plate 6 is made of material such as polymer material represented by PET. An expanded (air bubbles are included in the material) white PET material is especially suitable. If a material containing air bubbles is used, light can be scattered inside the reflection plate 8. This light-transmissive reflection plate 6 may have a single layer structure, or may have a laminated structure obtained by adhering sheets made of one or more polymer materials together with silicon or acrylic adhesive. The polymer material is not limited to PET but may be, for example, polyethylene, polypropylene, polystyrene, ABS plastics, polyvinyl chloride, polycarbonate, polyamide, polybutylene terephthalate, polyoxymethylene, polyacetal, and modified polyphenylene ether.

In the light-transmissive reflection plate 6, as will be described later, a plurality of through holes are formed in a central region including a position right above each LED light source 1 and in a peripheral region surrounding the central region so as to gradually increase the opening size thereof as getting farther from the position right above the corresponding LED light source 1. The through holes can be formed by punching work or cutting, for example. Further, the through holes may be formed to have a side wall perpendicular to the principal plane of the light-transmissive reflection plate 6 or a side wall inclining to the principal plane of the light-transmissive reflection plate 6 (in a forward tapered shape or reverse tapered shape), or to have the minimum (or maximum) opening size in the middle of the thickness of the light-transmissive reflection plate 6. The side wall of each through hole may have a smooth surface or may have a roughened surface so as to diffusely reflect light entering the side wall.

It should be noted that FIGS. 1A and 1B show an example of the surface light-emitting device of the present example and the form, arrangement, structure, quantity, or the like of each component may be modified as appropriate. For example, although the light-transmissive reflection plate 6 and the second diffusion member 7 are closely contacting in FIGS. 1A and 1B, the light-transmissive reflection plate 6 may be adjacent to the second diffusion member 7 with a gap put between them as long as the light coming from the light-transmissive reflection plate 6 can be sufficiently diffused in the second diffusion member 7. As for diffusion members, although the first diffusion member 3 and the second diffusion member 7 are provided in FIGS. 1A and 1B, it is also possible to omit the first diffusion member 3 when sufficient diffusion effect is acquired only by the second diffusion member 7. In addition, although FIGS. 1A and 1B show a structure in which the first diffusion member 3, the light-transmissive reflection plate 6, and the second diffusion member 7 are supported by the support pins 5, the structure may be such that they may be supported by projections or fitting parts provided on the backlight casing 8 when the first diffusion member 3, the light-transmissive reflection plate 6, and the second diffusion member 7 have sufficient hardness.

Hereafter, operations of the surface light-emitting device having the above-described structure will be described below.

FIGS. 2A to 2C illustrate the luminance distribution (relative intensity) of a single LED light source 1. The LED light source 1 has a package including one or more LEDs, and is of a top view type which emits light in the perpendicular direction of the package, and the luminance is the highest at the center of the LED light source 1 and becomes lower as getting farther from the center of the LED light source 1. The distribution viewed from the light-outgoing-surface side (first diffusion member 3 side) has an almost concentric shape around the LED light source 1. It should be noted that, even when the LED light source 1 includes LEDs with different colors, the center of the package can be deemed as the center of the LED light source 1 since the LEDs with different colors are arranged closely.

FIGS. 3A and 3B illustrate an arrangement of the LED light sources 1 of the present example. FIG. 3A is a top view and FIG. 3B is a cross-sectional view taken along the line IIIB-IIIB of FIG. 3A. The plurality of LED light sources 1 each having the above-described light emitting characteristic are arranged in openings provided on the bottom-surface reflection plate 2 on the backlight casing 8 at, for example, 28-mm pitch. The light emitted from this LED light sources 1 enters the light-transmissive reflection plate 6 arranged between the LED light sources 1 and the first diffusion member 3.

FIGS. 4A and 4B are top views of the light-transmissive reflection plate 6 of the present example. FIG. 4A is an overall view, and FIG. 4B is an enlarged view of a region corresponding to one LED light source 1 of FIG. 4A. In the light-transmissive reflection plate 6, through holes 6a are formed in a central region including a position right above each LED light source 1 (a portion superimposed on each LED light source 1 when viewed from the light-outgoing-surface side) and the peripheral region surrounding the central region, in other words, through holes 6a are formed on the entire surface. These through holes 6a are prepared such that their opening size becomes gradually larger as getting farther from the position right above the corresponding LED light source 1. It should be noted that FIGS. 4A and 4B show an example of the light-transmissive reflection plate 6 of the present example, and the quantity, the interval, and the arrangement pattern of the through holes 6a and the variation of their opening sizes can be set as appropriate according to the light emitting characteristic, the quantity, the interval and the arrangement pattern of the LED light sources 1.

A part of light emitted from the LED light sources 1 passes through the through holes 6a directly and the remainder enters the light-transmissive reflection plate 6. A part of the light entered into the light-transmissive reflection plate 6 passes through the light-transmissive reflection plate 6 according to its material and the remainder is reflected. The light reflected by the light-transmissive reflection plate 6 is further reflected by the bottom-surface reflection plate 2 arranged on the bottom surface of the backlight casing 8 and enters into the light-transmissive reflection plate 6 again. Then the light which has passed through the through holes 6a and the light which has passed through the light-transmissive reflection plate 6 are diffused in the second diffusion member 7 arranged on the light-outgoing-surface side of the light-transmissive reflection plate 6, and enter into the first diffusion member 3 and the optical sheet 4. After that, the light whose in-plane luminance distribution is smoothed more enters into the liquid crystal panel 9 eventually.

Thus, the luminance uniformity can be improved while increasing the luminance of the entire surface light-emitting device by making the light-transmissive reflection plate 6 transmit light, forming through holes 6a at a position right above each LED light source 1 and surrounding positions, and increasing the opening sizes of the through holes gradually as getting farther from the position right above the corresponding LED light source 1. In addition, since the second diffusion member 7 is arranged on the light-outgoing-surface side (or the light-entering-surface side) of the light-transmissive reflection plate 6, the light that has passed through the through holes 6a of the light-transmissive reflection plate 6 never reaches to the liquid crystal panel 9 side directly, and thus it is possible to maintain the luminance uniformity in an excellent condition.

Hereafter, advantageous effects of the structure of the present example will be described below.

FIGS. 5A, 5B and 5C are diagrams for comparison of the structure according to the present example with the structures of JP-B No. 4280283 and JP-A No. 2012-174372. FIG. 5A illustrates the structure of the present example, which includes an LED light source 1, a light-transmissive reflection plate 6 and a second diffusion member 7. FIG. 5B illustrates the structure of JP-B No. 4280283, which includes an LED light source 1 and a light-transmissive reflection plate 10. FIG. 5C illustrates a structure of JP-A No. 2012-174372, which includes an LED light source 1 and a non-light-transmissive reflection plate 20.

The structure of the present example is now compared with those of JP-B No. 4280283 and JP-A No. 2012-174372. In the present example, the second diffusion member 7 is arranged at a position close to (adjacent to) the light-transmissive reflection plate 6, whereas in JP-B No. 4280283 and JP-A No. 2012-174372 any diffusion member is not arranged at a position close to (adjacent to) the light-transmissive reflection plate 10 or the non-light-transmissive reflection plate 20. Further, in the present example a through hole 6a is formed in the central region including the position directly above the LED light source 1, whereas in JP-B No. 4280283 any through hole 10a is not formed in the central region including the position directly above the LED light source 1. Furthermore, the present example uses a light-transmissive reflection plate 6 capable of transmitting light for a reflection plate, whereas JP-A No. 2012-174372 uses a non-light-transmissive reflection plate 20 which does not transmit light.

FIGS. 6A to 8A illustrate simulation results of the luminance distribution (relative intensity) in a region corresponding to one LED light source in the structures of the present example, JP-B No. 4280283 and JP-A No. 2012-174372. It should be noted that, in order to make advantageous effects of the present example easy to understand, the diagram of the present example shows the luminance distribution of light which has passed through the second diffusion member 7, that of JP-B No. 4280283 shows the luminance distribution of light which has passed through the light-transmissive reflection plate 10, and that of JP-A No. 2012-174372 shows the luminance distribution of light which has passed through the non-light-transmissive reflection plate 20. Since the structure of WO2011/162258 is similar to the structure of JP-B No. 4280283, the descriptions about WO2011/162258 are omitted.

As shown in FIG. 6B, in the structure of the present example, a through hole 6a is formed right above the LED light source 1, the light-transmissive reflection plate 6 is capable of transmitting light, and the second diffusion member 7 is arranged on the light-transmissive reflection plate 6. Such a structure reduces the variation of luminance intensity (luminance non-uniformity) while making luminance at the position right above the LED light source 1 high as shown in FIG. 6A. Further, luminance in the peripheral region is increased by increasing the opening sizes of the through holes 6a gradually as getting farther from the position right above the LED light source 1, and thus the variation of luminance intensity is reduced.

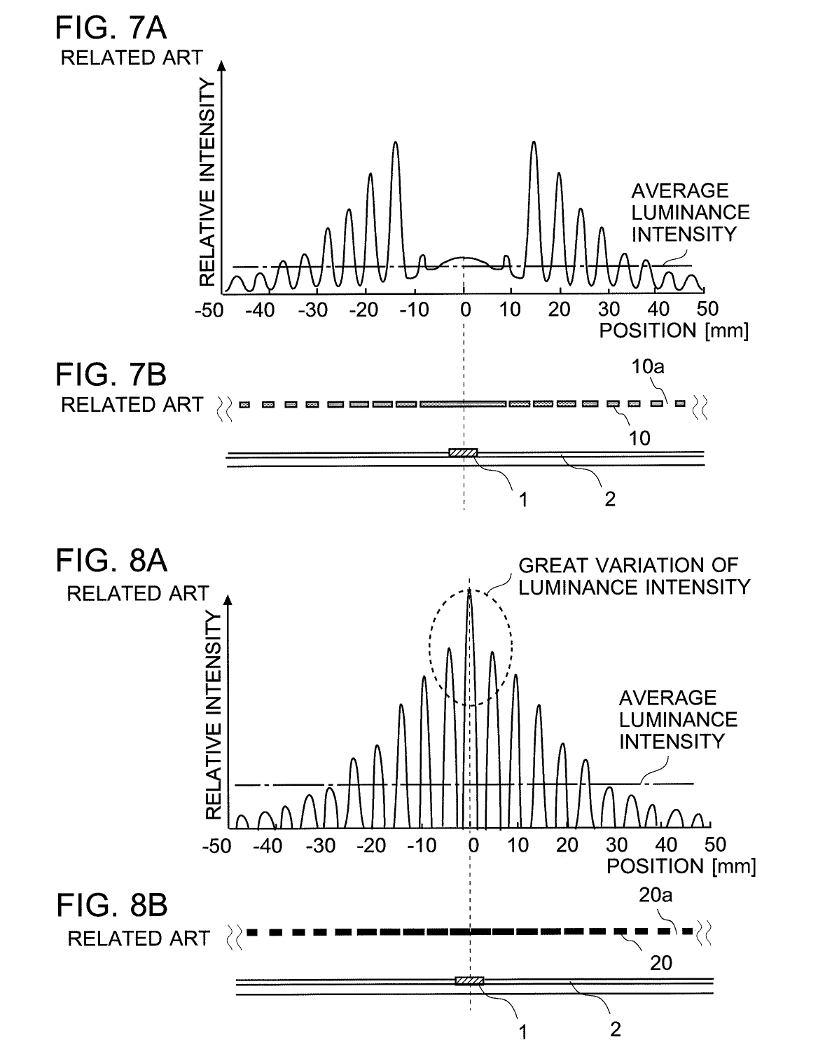

Meanwhile, in the structure of JP-B No. 4280283 shown in FIG. 7B, there are no through holes 10a in the central region, which decreases the luminance in the central region remarkably. As a result, the average luminance intensity is decreased and the variation of luminance intensity is large as compared with the structure of to the present example. Further, in the structure of JP-B No. 4280283, no diffusion member is arranged on the light-transmissive reflection plate 10, which increases the variation of luminance intensity at the positions corresponding to the through holes 10a and other positions in comparison with the structure of the present example.

In the structure of JP-A No. 2012-174372 shown in FIG. 8B, a through hole 20a is formed in the central region including the position right above the LED light source 1, which increases the average luminance intensity. However, since the non-light-transmissive reflection plate 20 is used as a reflection plate, the luminance at the position corresponding to the through hole 20a remarkably increases and the variation of luminance intensity becomes large. Further, since no diffusion member is arranged on the non-light-transmissive reflection plate 20, in-plane luminance non-uniformity at the position corresponding to the through hole 20a and other positions is large as compared with the structure of to the present example.

FIG. 9 is a diagram that summarizes values of the peak luminance intensity divided by the average luminance intensity and of the average luminance intensity obtained from the graphs in FIGS. 6A, 7A and 8A. As shown in FIG. 9, it can be recognized that the structure of the present example is better in both the uniformity denoted by the value of the peak luminance intensity divided by the average luminance intensity and the average luminance intensity.

Specifically, comparing the present example and JP-B No. 4280283, through hole 10a is not formed right above the LED light source 1 in JP-B No. 4280283, whereas through hole 6a is formed right above the LED light source 1 in the present example. Accordingly, in the present example, such a structure improves the luminance in the central region including the position right above the LED light source 1. Furthermore, in the present example, the through hole located farther from the position right above the LED light source 1 has a greater opening size in the peripheral region, which improves the luminance in the peripheral region. The luminance improvement in both of the central region and the peripheral region, improves the average luminance intensity. In the structure of JP-B No. 4280283, the average luminance intensity is small and the difference in luminance between the positions at the through holes 10a and other positions is large, whereas in the present example, the average luminance intensity is large and the difference in luminance between the positions at the through holes 6a and other positions is small. Further in the present example, light which has passed through the through holes 6a is dispersed by the second diffusion member 7 arranged adjacent to the reflection plate. Such a structure reduces the value of the peak luminance intensity divided by the average luminance intensity, which results in an improved luminance uniformity.

Next, the present example will be compared with JP-A No. 2012-174372. Since the non-light-transmissive reflection plate 20 is used in JP-A No. 2012-174372, the luminance in portions other than the through holes 20a is remarkably low. However, since the present example uses the light-transmissive reflection plate 6, the reduction of luminance in portions other than the through holes 6a can be suppressed, which results in an increase of the average luminance intensity. Further, since the non-light-transmissive reflection plate 20 is used in JP-A No. 2012-174372, the difference in luminance between the positions of the through holes 20a and other positions is large. However, since the present example uses the light-transmissive reflection plate 6 and the second diffusion member 7, which reduces the difference in luminance between the positions of the through holes 6a and other positions. Accordingly, the value of the peak luminance intensity divided by the average luminance intensity becomes small and it results in an improvement of the luminance uniformity.

### Example 2

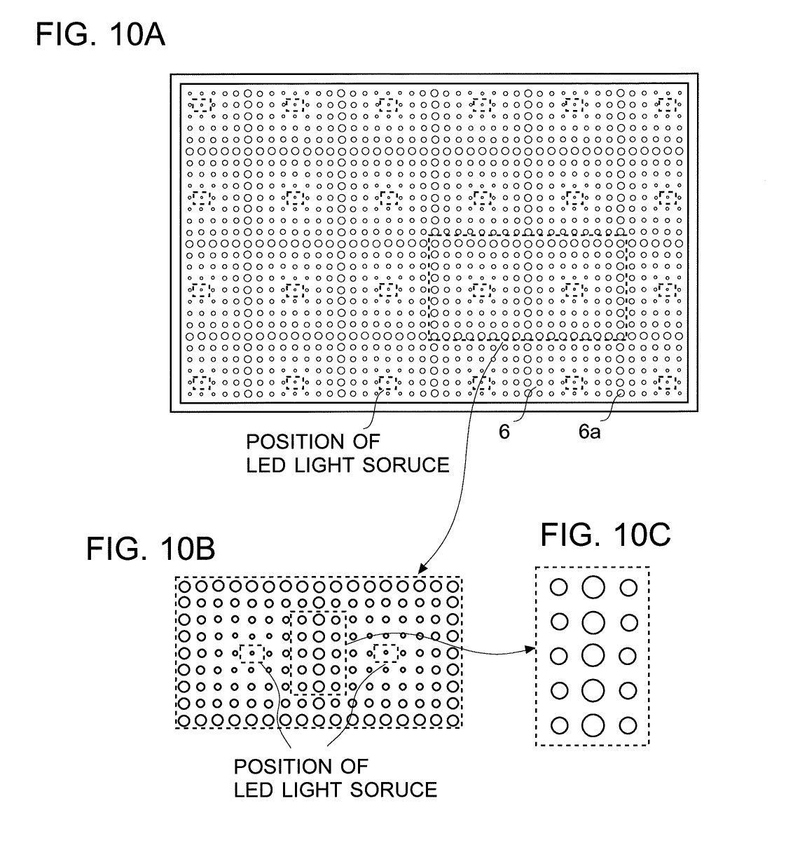

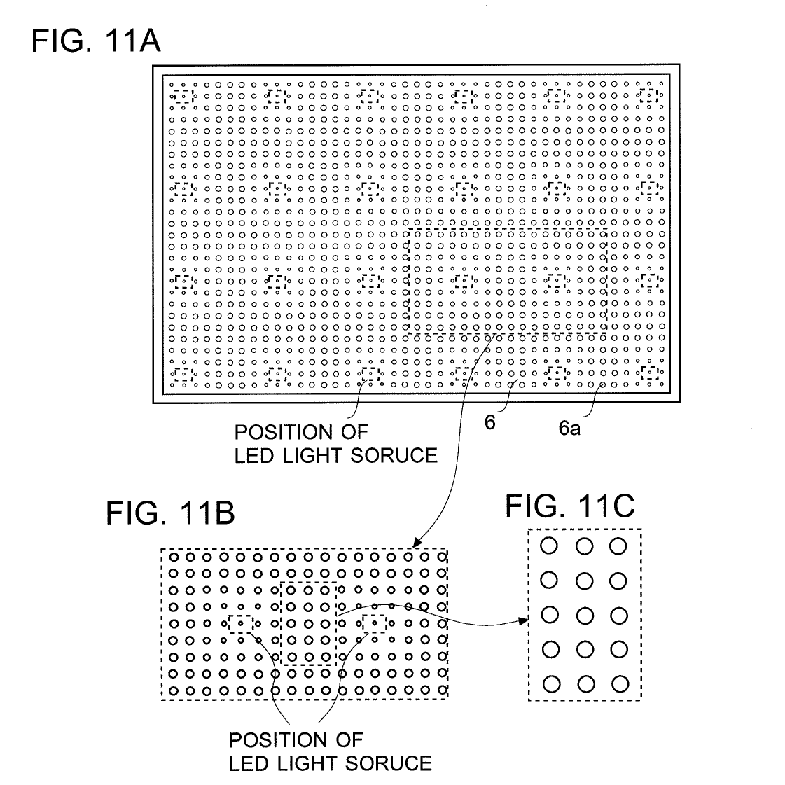

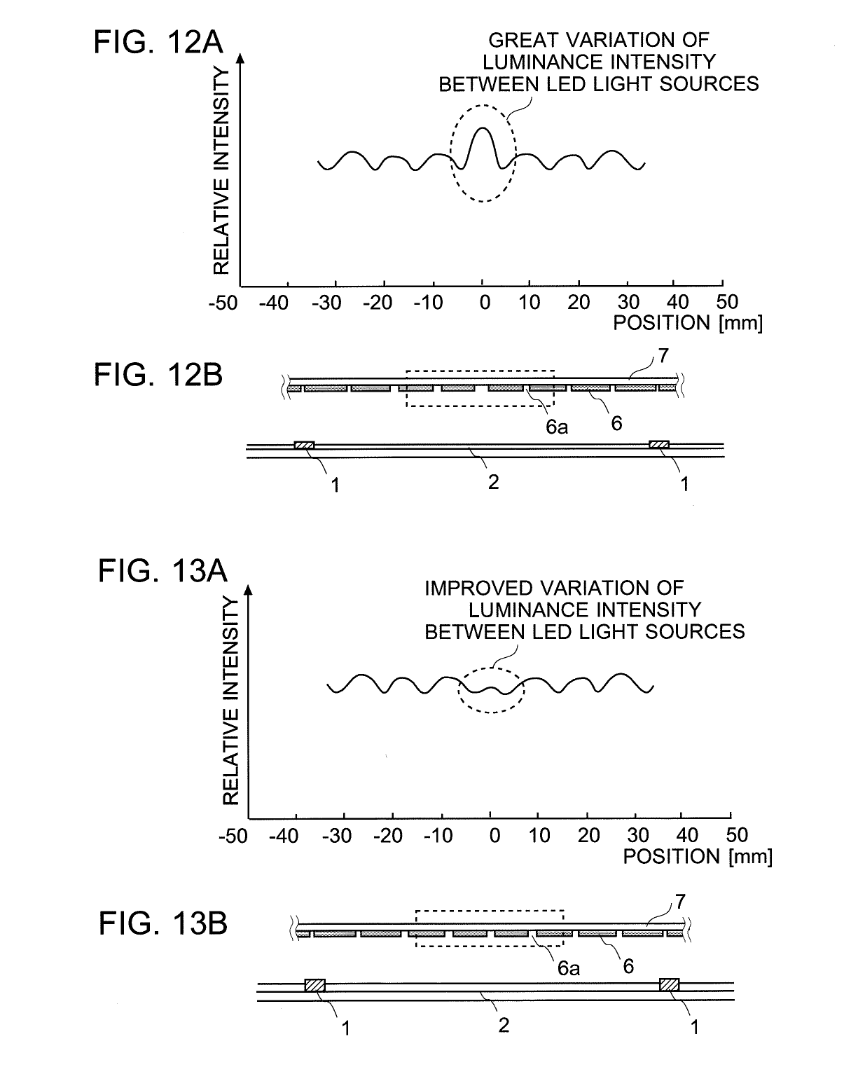

Next, the surface light-emitting device and the liquid crystal display apparatus of EXAMPLE 2 will be described with reference to FIGS. 10A to 13B. FIG. 10A and FIG. HA are overall views of the light-transmissive reflection plate. FIG. 10B and FIG. 11B are enlarged views of a region corresponding to two neighboring LED light sources. FIG. 10C and FIG. 11C are enlarged views of the region corresponding to the middle of the neighboring LED light sources in FIGS. 10B and 11B. FIGS. 12A and 12B and FIGS. 13A and 13B illustrate the luminance distribution of the light which has passed through the light-transmissive reflection plate of the present example. It should be noted that present example shows an alternative arrangement of the LED light sources and the through holes of the light-transmissive reflection plate 6 and the present example is the same as EXAMPLE 1 with respect to the other components of the surface light-emitting device and the liquid crystal display apparatus.

In EXAMPLE 1, there were given descriptions about the luminance distribution, which were focused on the region corresponding to one LED light source 1. In a structure that a plurality of LED light sources 1 are arrayed in the backlight casing 8, optical paths of light rays from each LED light source 1 influence the region of the neighboring LED light source 1, too. Accordingly, as shown in FIGS. 10A to 10C, formation of through holes 6a such that through holes 6a in a region corresponding to the middle of neighboring LED light sources 1 have the greatest opening size (see the center column of through holes in FIG. 10C), can increase the luminance in the region corresponding to the middle of the neighboring LED light sources 1. Accordingly, in order to obtain more improved luminance uniformity, the present example employs, as shown in FIGS. 11A, 11B and 11C, a region corresponding to the middle of neighboring LED light sources 1, and in the region through holes 6a has the same and constant opening size (see FIG. 11C).

The effect as a result of such a difference in the structure will be described with reference to FIGS. 12A and 12B and FIGS. 13A and 13B. FIGS. 12A and 12B illustrate the luminance distribution in a region between the LED light sources 1 in the structure of FIGS. 10A to 10C. FIGS. 13A and 13B illustrate the luminance distribution in the region between the LED light sources 1 in the structure of FIGS. 11A, 11B and 11C. FIGS. 12A and 12B are compared with FIGS. 13A and 13B. In the structure in which the opening sizes of through holes 6a are gradually changed between the LED light sources 1 so as to make the opening size maximum at the center of the LED light sources 1 as shown in FIGS. 10A to 10C and FIG. 12B, the luminance intensity becomes high at the center of the LED light sources 1 due to the interaction of light emitted from both LED light sources 1 (see FIG. 12A), and then, the variation of the luminance intensity (non-uniformity) becomes large. Meanwhile, in another structure in which there is provided a region corresponding to the center of the LED light sources 1 and through holes 6a have the constant and same opening size in the region as shown in FIGS. 11A to 11C and FIG. 13B, the luminance at the center of the neighboring LED light sources 1 can be reduced (see FIG. 13A), and then the brightness unevenness (in-plane luminance intensity of non-uniformity) can be improved.

This effect will be described now by comparing with JP-B No. 4280283, JP-A No. 2012-174372. In both JP-B No. 4280283 and JP-A No. 2012-174372, each point light source including one LED is comparted with a casing or a housing, and through holes are formed so as to gradually increase the opening size thereof as getting farther from the position directly above each LED light source 1. When this structure is applied to a case where a plurality of LEDs are arrayed in one casing, which results in the structure of FIGS. 10A to 10C and the through holes have the maximum opening size in the middle of neighboring LED light sources 1. Meanwhile, in the present example, as shown in FIGS. 11A to 11C, there is provided a region corresponding to the middle of the neighboring LED light sources 1 and through holes 6a having the constant and same opening size are formed in the region. Such a structure can ease the interaction between light coming from both LED light sources 1, and thus the luminance uniformity can be improved.

In FIGS. 11A to 11C, the region includes three lines of through holes 6a having the same and constant opening size. However, the width and length of the region where the opening sizes are constant can be set as appropriate according to the luminance distribution and the interval of the LED light sources 1. Further, FIG. 11A illustrates an arrangement of LED light sources 1 located at grid points (lines connecting adjacent LED light sources 1 form a rectangle), and the regions in each of which through holes 6a have the same and constant opening size are arranged in a shape of a rectangular frame surrounding each of the LED light sources 1. Alternatively, when the LED light sources 1 are arranged in zigzag (lines connecting adjacent LED light sources 1 forms a triangle), the regions in each of which through holes 6a have the same and constant opening size are arranged in a shape of a triangular frame surrounding each of the LED light sources 1. That is, a figure formed by connecting the LED light sources 1 and the shape formed by the regions where the opening sizes are the constant and same are analogue with each other. Further, FIGS. 12A and 13A show the simulation results in the case where the second diffusion member 7 is arranged on the light-transmissive reflection plate 6. However, the advantageous effect as a result of a region where opening sizes are constant between neighboring LED light sources 1 is the same as a case where there is no second diffusion member 7.

### Example 3

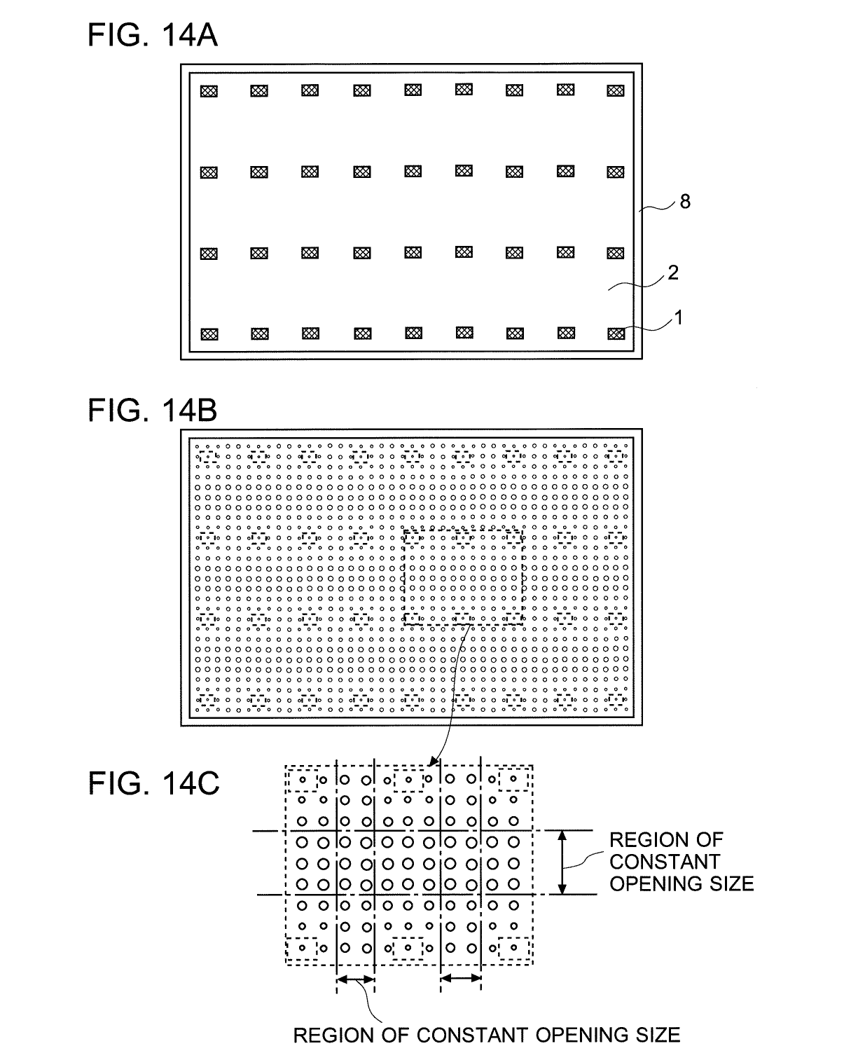

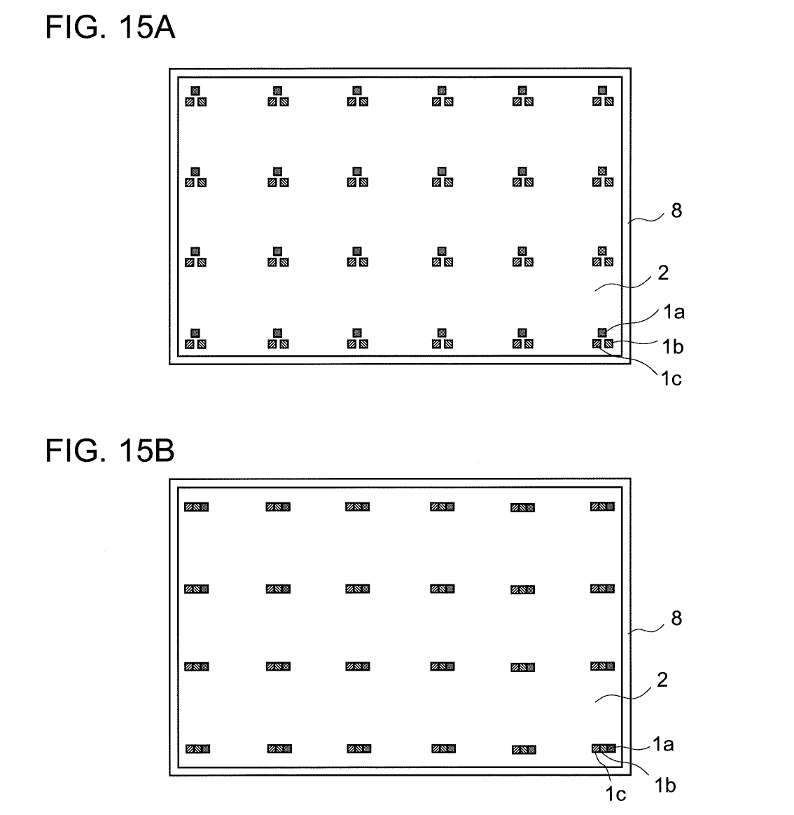

Next, the surface light-emitting device and the liquid crystal display apparatus of EXAMPLE 3 will be described with reference to FIGS. 14A, 14B and 14C. FIG. 14A illustrates an arrangement of the LED light sources in the surface light-emitting device of the present example. FIG. 14B is an overall view of the light-transmissive reflection plate. FIG. 14C is a partially enlarged view of FIG. 14B. It should be noted that the present example shows an alternative arrangement of the LED light sources and the through holes in the light-transmissive reflection plate 6. With respect to other components of the surface light-emitting device and the liquid crystal display apparatus, the arrangement and structure of the present example are the same as those of EXAMPLE 1 and EXAMPLE 2.

In the above-described EXAMPLE 2, the LED light sources 1 are arranged at the regular intervals (or at the same pitch) in both of the longitudinal direction and the lateral direction of the backlight casing 8. Alternatively, the LED light sources 1 may be arranged at a pitch in the longitudinal direction and at another pitch in the lateral direction which are different from each other, as shown in FIG. 14A.

For example, in a structure that, as illustrated in FIG. 14A, the pitch of the LED light sources 1 in the longitudinal direction of the backlight casing 8 is made smaller in comparison of the pitch of the LED light sources 1 in the lateral direction of the backlight casing 8, through holes 6a are formed in the light-transmissive reflection plate 6 in accordance with the pitches of the LED light sources 1 as illustrated in FIG. 14B. In EXAMPLE 2, the width of the region where through holes have the constant and same opening size (hereinafter, referred to as the region of constant opening size), extending between the neighboring LED light sources 1 in the longitudinal direction of the backlight casing 8 is the same as the width of the region of constant opening size extending between the neighboring LED light sources 1 in the lateral direction of the backlight casing 8. If the width of the region of constant opening size becomes greater in comparison with the pitch of the LED light sources 1 in the corresponding direction, there is a possibility that the luminance uniformity can be deteriorated.

In view of that, in order to maintain the luminance uniformity in an excellent condition even in the structure that the pitch of the LED light sources 1 in the longitudinal direction of the backlight casing 8 is different from that in the lateral direction of the backlight casing 8, the present example employs the following arrangement of the through holes 6a. That is, the width of the region of constant opening size extending between the neighboring LED light sources 1 in the longitudinal direction of the backlight casing 8 differs from the width of the region extending between the neighboring LED light sources 1 in the lateral direction of the backlight casing 8, as shown in FIG. 14C. Specifically, as for the smaller-pitch direction, which is the direction in which the LED light sources 1 are arranged at the smaller pitch, the region of constant opening size having the width of the smaller-pitch direction is smaller in width than the region of constant opening size having the width of the other (longer-pitch) direction. Thereby, the luminance non-uniformity of regions between the LED light sources 1 can be reduced and thus the luminance uniformity can be maintained.

### Example 4

Next, EXAMPLE 4 of the surface light-emitting device and the liquid crystal display apparatus is described using FIGS. 15A and 15B. Each of FIGS. 15A and 15B illustrates an arrangement of the LED light sources in the surface light-emitting device of the present example. It should be noted that the present example shows an alternative arrangement of the LED light sources 1 and other components of the surface light-emitting device and the liquid crystal display apparatus of the present example are the same as those in EXAMPLE 1, EXAMPLE 2 and EXAMPLE 3.

Additionally, each LED light source 1 is illustrated as one LED in the above descriptions of EXAMPLE 1, EXAMPLE 2 and EXAMPLE 3, each LED light source 1 may be formed by combining LEDs with different colors such as RGB (R-LED 1a, G-LED 1b and B-LED 1c, where the combination of colors is not limited to RGB as long as such colored LEDs can be used for a backlight light source. In that case, for example, as shown in FIG. 15A, a cluster of LEDs may be arranged as each LED light source 1, where light from LEDs with different colors in the cluster are mixed to form white light. The cluster may have a structure that the LEDs with RGB colors are arranged in line or arranged at apexes of a triangle.

In a structure that each LED light source 1 includes an R-LED, G-LED and B-LED (LEDs with different colors) arranged in line, it is desirable to array the LEDs with different colors along the arranging direction of the clusters constituted by the LEDs with different colors as shown in FIG. 15B. The cluster may further includes W-LEDs (white LEDs) arranged at both sides of R-LED, G-LED and B-LED arranged in line. Thus, by arranging LEDs with different colors along the arranging direction of the clusters, color mixture can be promoted as a result of the interaction among light of LEDs of neighboring clusters.

In any case, coloring in the region where light in each of RGB colors directly enters into the liquid crystal panel 9 can be suppressed by arranging the second diffusion member 7 on the light-transmissive reflection plate 6. Thus color uniformity can be maintained even when an LED light source 1 formed by combining LEDs with different colors is used. In another structure that a plurality of LEDs form each LED light source 1, the position right above the LED light source 1 may be the position right above any one of the LEDs. It is preferable that in order to suppress the above-described coloring, the position right above the LED light source 1 is a position directly above the center of gravity of the cluster. In other words, a through hole at the position right above each LED light source 1 may be located right above any one of the LEDs with RGB colors or right above a gravity point of the cluster.

The present invention is not limited to the above-described embodiments and examples. Unless deviating from the spirit of the present invention, the structure can be modified as appropriate.

For example, in the above examples, each through holes 6a formed in the light-transmissive reflection plate 6 has a circular shape with the edge extending perpendicular to the light-transmissive reflection plate 6. Alternatively, the shape may be an ellipse or a rectangle, for example. Further, the shape of the through holes 6a may be modified. For example, the through hole 6a may have a circular shape at the position right above the LED light source 1, and the through hole 6a located farther from the position right above the LED light source 1 may have an ellipse shape with the greater longer axis.

The present invention can be used for a surface light-emitting device of a directly-light type which can convert light from point light sources with strong directivity into planar light, and a liquid crystal display apparatus that uses the surface light-emitting device as a backlight device.

1. A surface light-emitting device comprising:
a casing;
one or a plurality of point light sources arranged on a bottom surface of the casing;
a first diffusion member arranged at a light-outgoing side of the one or plurality of point light sources to be separated from the one or plurality of point light sources;
a reflection plate capable of transmitting light and arranged between the one or plurality of point light sources and the first diffusion member, wherein through holes are formed in a region of the reflection plate corresponding to each of the one or plurality of point light sources, the through holes in the region are located at a right above position of the corresponding point light source and positions surrounding the right above position such that the through hole located farther from the right above position has a greater opening size; and
a second diffusion member adjacent to the reflection plate and facing the one or plurality of point light sources or the first diffusion member.

2. The surface light-emitting device of claim 1,
wherein the plurality of point light sources are arrayed at regular intervals on the bottom surface of the casing,
the reflection plate includes constant-opening regions in each of which through holes having a same opening size are formed, and
each of the constant-opening regions is located above a middle of the neighboring point light sources.

3. The surface light-emitting device of claim 2,
wherein the plurality of point light sources are located at grid points, and
the constant-opening regions of the reflection plate are arranged in a shape of a rectangular frame surrounding each of the grid points.

4. The surface light-emitting device of claim 3,
wherein the plurality of point light sources are arrayed in a longitudinal direction of the casing at a first pitch and in a lateral direction of the casing at a second pitch, where the first pitch differs from the second pitch, and
a width of the constant-opening region extending between the neighboring point light sources in the longitudinal direction of the casing differs from a width of the constant-opening region extending between the neighboring point light sources in the lateral direction of the casing.

5. The surface light-emitting device of claim 1,
wherein each of the one or plurality of point light sources consists of a white LED.

6. The surface light-emitting device of claim 1,
wherein each of the one or plurality of point light sources consists of a cluster of LEDs with multiple colors, and
the through hole at the right above position of the each of the one or plurality of point light sources is located right above any one of the LEDs with multiple colors or right above a gravity point of the cluster.

7. The surface light-emitting device of claim 6,
wherein each of the one or plurality of point light sources consists of a cluster of LEDs with three colors including a red LED, green LED and blue LED, the LEDs with three colors being arranged in line or at apexes of a triangle.

8. The surface light-emitting device of claim 6,
wherein each of the one or plurality of point light sources consists of a cluster of LEDs including a red LED, green LED and blue LED arranged in line and white LEDs arranged at both sides of the line of the red LED, green LED and blue LED.

9. A liquid crystal display apparatus comprising:
the surface light-emitting device of claim 1; and
a liquid crystal panel facing a light-emitting surface of the surface light-emitting device.
